(19) United States
(12) Patent Application Publication
(10) Pub. No.: US 2025/0151124 A1
(43) Pub. Date: May 8, 2025

(54) RANDOM ACCESS METHOD, APPARATUS, AND SYSTEM

(71) Applicant: HUAWEI TECHNOLOGIES CO., LTD., Shenzhen (CN)

(72) Inventors: Chuili KONG, Hangzhou (CN); Ying CHEN, Hangzhou (CN); Xiaolu WANG, Hangzhou (CN); Yu WANG, Hangzhou (CN); Yinggang DU, Shenzhen (CN)

(21) Appl. No.: 19/018,590

(22) Filed: Jan. 13, 2025

Related U.S. Application Data
(63) Continuation of application No. PCT/CN2023/105368, filed on Jun. 30, 2023.

(30) Foreign Application Priority Data
Jul. 13, 2022 (CN) 202210822460.7

(51) Int. Cl. H04W 74/0833; H04W 76/38

(52) U.S. Cl. CPC H04W 74/0833; H04W 76/38

(57) ABSTRACT

This application provides a random access method, an apparatus, and a system, which are applied to the field of communication technologies. The random access method provided in this application includes: First, a terminal device obtains first configuration information, where the first configuration information indicates a maximum quantity of repeated sending times of a preamble, and the maximum quantity of repeated sending times of the preamble is greater than 200. Then, the terminal device sends one or more preambles to a network device based on the first configuration information. According to the method, a current maximum quantity of repeated sending times of the preamble is extended, so that a decoding threshold for decoding the preamble by the network device is reduced, and a low uplink budget requirement of some scenarios can be met.

### CROSS-REFERENCE TO RELATED APPLICATIONS

This application is a continuation of International Application No. PCT/CN 2023/105368, filed on Jun. 30, 2023, which claims priority to Chinese Patent Application No. 202210822460.7, filed on Jul. 13, 2022. The disclosures of the aforementioned applications are hereby incorporated by reference in their entireties.

### TECHNICAL FIELD

This application relates to the field of communication technologies, and in particular, to a random access method, an apparatus, and a system.

### BACKGROUND

A satellite communication system is integrated with a terrestrial 5th generation (5th Generation, 5G) network, to gather strengths and overcome weaknesses, jointly form a sea-land-space-air-ground integrated communication network with seamless global coverage, and meet various service requirements of users. This is an important development direction of future communication. To achieve this target, a non-terrestrial network (non-terrestrial network, NTN) is an important technical support. An NTN system includes nodes such as a satellite network, a high-altitude platform, and an uncrewed aerial vehicle. In the NTN system, a terminal device may communicate with a base station on a satellite.

However, for the NTN system, the satellite is far away from the ground, and there is a factor such as rain attenuation. Consequently, a link budget is usually insufficient. Especially for an uplink, a handheld terminal device usually uses omnidirectional antennas or a small quantity of antennas, and an antenna gain of the handheld terminal device is low. Consequently, an uplink budget in the NTN system becomes a severe bottleneck.

In random access, that the terminal device completes uplink synchronization is an important part in communication. Therefore, the random access is critical to meeting a link budget. How to improve a random access procedure to meet the uplink budget required by the NTN system is an urgent problem to be resolved currently.

### SUMMARY

Embodiments of this application provide a random access method, an apparatus, and a system, to resolve a problem that an uplink budget required by an NTN system cannot be met.

To achieve the foregoing objective, the following technical solutions are used in embodiments of this application.

According to a first aspect, a random access method is provided. The method may be performed by a terminal device, may be performed by a component (such as a processor, a chip, or a chip system) of the terminal device, or may be implemented by a logical module or software that can implement all or a part of functions of the terminal device. The method includes: obtaining first configuration information, where the first configuration information indicates a maximum quantity of repeated sending times of a preamble, and the maximum quantity of repeated sending times of the preamble is greater than 200; and sending one or more preambles to a network device based on the first configuration information.

According to the random access method provided in this embodiment of this application, a maximum quantity of repeated sending times of the preamble is extended to more than 200. When the terminal device sends the preamble based on the maximum quantity of repeated sending times of the preamble, a final quantity of possible sending times of the preamble is increased accordingly, so that a decoding threshold for decoding the preamble by the network device can be reduced, and a link budget is increased to meet an uplink budget requirement of a scenario.

With reference to the first aspect, in a possible design, the sending one or more preambles to a network device based on the first configuration information includes: sending the one or more preambles to the network device based on the first configuration information and a preconfigured preamble transmit power.

In some scenarios in which uplink budgets are severely insufficient, for example, an NTN system, if the terminal device performs, based on a current power ramping mechanism, power ramping each time the terminal device sends a preamble, a required uplink budget may still fail to be met even if a transmit power of the preamble is a preconfigured maximum preamble transmit power. However, according to this solution, each time the terminal device sends the preamble, the terminal device sends the preamble based on the preconfigured preamble transmit power, and does not need to perform power ramping step by step, so that the decoding threshold for decoding the preamble by the network device can be reduced, and an uplink budget is increased to meet the uplink budget requirement of the scenario.

With reference to the first aspect, in a possible design, the first configuration information is carried in information that is about a maximum quantity of preamble transmission times and that is broadcast by the network device, or the first configuration information is carried in power ramping step information broadcast by the network device, or the first configuration information is carried in preamble target receive power information broadcast by the network device. According to this solution, a plurality of methods for obtaining the first configuration information are provided, and numerical or function extension is performed on current information about the maximum quantity of preamble transmission times, power ramping step information, or preamble target receive power information, to ensure compatibility with an existing protocol.

With reference to the first aspect, in a possible design, the method further includes: receiving a random access response message from the network device, and repeatedly sending a Msg3 to the network device for N times, where N is a positive integer greater than 1.

In an existing solution, the terminal device needs to send the Msg3 to the network device only once. However, in some scenarios in which uplink budgets are severely insufficient, for example, an NTN system, if the network device receives the Msg3 only once, a decoding threshold for decoding the Msg3 is high. Consequently, the uplink budget is insufficient. According to the random access method provided in this embodiment of this application, the terminal device may repeatedly send the Msg3 to the network device, and a decoding threshold for decoding the Msg3 by the network device is correspondingly reduced, so that the uplink budget can be increased to meet the uplink budget requirement of the scenario.

With reference to the first aspect, in a possible design, a value of N is determined based on a preamble sequence format of the preamble or a quantity of repeated sending times of the preamble. According to this solution, a quantity of repeated sending times of the Msg3 may be implicitly indicated by using the preamble sequence format of the preamble or the quantity of repeated sending times of the preamble.

With reference to the first aspect, in a possible design, a preamble sequence in the preamble is in a first preamble sequence group, and all preamble sequences in the first preamble sequence group are preamble sequences used for uplink coverage enhancement. According to this solution, a preamble sequence group applied to an uplink coverage enhancement scenario may be newly defined.

With reference to the first aspect, in a possible design, a preamble sequence in the preamble is in a preamble sequence group A or a preamble sequence group B.

With reference to the first aspect, in a possible design, a quantity of repetition times of the preamble sequence in the preamble is determined based on a first parameter of a satellite. The random access method provided in this embodiment of this application may be applied to an NTN system. The terminal device may determine the quantity of repetition times of the preamble sequence in the preamble based on the first parameter of the satellite, to reduce a demodulation threshold of the preamble sequence, so that a reduced demodulation threshold meets an uplink budget requirement of the NTN system.

With reference to the first aspect, in a possible design, the first parameter of the satellite includes a satellite type of the satellite and/or position information of the satellite.

With reference to the first aspect, in a possible design, the position information of the satellite includes an orbital altitude of the satellite and/or an elevation angle of the satellite.

With reference to the first aspect, in a possible design, a length of the preamble sequence in the preamble is 139, and the quantity of repetition times of the preamble sequence in the preamble is greater than 4. Alternatively, a length of the preamble sequence in the preamble is 839, and the quantity of repetition times of the preamble sequence in the preamble is greater than 12. According to this solution, for different lengths of the preamble sequence, the quantity of repetition times of the preamble sequence may be increased, so that a decoding threshold of the preamble meets the uplink budget requirement of the NTN system.

According to a second aspect, a random access method is provided. The method may be performed by a network device, may be performed by a component (such as a processor, a chip, or a chip system) of the network device, or may be implemented by a logical module or software that can implement all or a part of functions of the network device. The method includes: receiving one or more preambles from a terminal device, where a maximum quantity of repeated sending times of the preamble is greater than 200; and sending, by the network device, a random access response message to the terminal device.

According to the random access method provided in this embodiment of this application, a maximum quantity of repeated sending times of the preamble is extended to more than 200. When the terminal device sends the preamble based on the maximum quantity of repeated sending times of the preamble, a final quantity of possible sending times of the preamble is increased accordingly, so that a decoding threshold for decoding the preamble by the network device can be reduced, and a link budget is increased to meet an uplink budget requirement of a scenario.

With reference to the second aspect, in a possible design, before the receiving one or more preambles from a terminal device, the method further includes: sending first configuration information to the terminal device, where the first configuration information indicates the maximum quantity of repeated sending times of the preamble. According to this solution, the network device may indicate the maximum quantity of repeated sending times of the preamble to the terminal device.

With reference to the second aspect, in a possible design, the one or more preambles are sent based on a preconfigured preamble transmit power.

In some scenarios in which uplink budgets are severely insufficient, for example, an NTN system, if the terminal device performs, based on a current power ramping mechanism, power ramping each time the terminal device sends a preamble, a required uplink budget may still fail to be met even if a transmit power of the preamble is a preconfigured maximum preamble transmit power. However, according to this solution, each time the terminal device sends the preamble, the terminal device sends the preamble based on the preconfigured preamble transmit power, and does not need to perform power ramping step by step, so that the decoding threshold for decoding the preamble by the network device can be reduced, and an uplink budget is increased to meet the uplink budget requirement of the scenario.

With reference to the second aspect, in a possible design, the first configuration information is carried in information that is about a maximum quantity of preamble transmission times and that is broadcast by the network device, or the first configuration information is carried in power ramping step information broadcast by the network device, or the first configuration information is carried in preamble target receive power information broadcast by the network device.

According to this solution, a plurality of methods for obtaining the first configuration information are provided, and numerical or function extension is performed on current information about the maximum quantity of preamble transmission times, power ramping step information, or preamble target receive power information.

With reference to the second aspect, in a possible design, the method further includes: receiving a Msg3 repeatedly sent by the terminal device for N times, where N is a positive integer greater than 1.

In an existing solution, the terminal device needs to send the Msg3 to the network device only once. However, in some scenarios in which uplink budgets are severely insufficient, for example, an NTN system, if the network device receives the Msg3 only once, a decoding threshold for decoding the Msg3 is high. Consequently, the uplink budget is insufficient. According to the random access method provided in this embodiment of this application, the terminal device may repeatedly send the Msg3 to the network device, and a decoding threshold for decoding the Msg3 by the network device is correspondingly reduced, so that the uplink budget can be increased to meet the uplink budget requirement of the scenario.

With reference to the second aspect, in a possible design, a value of N is determined based on a preamble sequence format of the preamble or a quantity of repeated sending times of the preamble. According to this solution, a quantity of repeated sending times of the Msg3 may be implicitly indicated by using the preamble sequence format of the preamble or the quantity of repeated sending times of the preamble.

With reference to the second aspect, in a possible design, a preamble sequence in the preamble is in a first preamble sequence group, and all preamble sequences in the first preamble sequence group are preamble sequences used for uplink coverage enhancement. According to this solution, a preamble sequence group applied to an uplink coverage enhancement scenario may be newly defined.

With reference to the second aspect, in a possible design, a preamble sequence in the preamble is in a preamble sequence group A or a preamble sequence group B.

With reference to the second aspect, in a possible design, a quantity of repetition times of the preamble sequence in the preamble is determined based on a first parameter of a satellite. The random access method provided in this embodiment of this application may be applied to an NTN system. The terminal device may determine the quantity of repetition times of the preamble sequence in the preamble based on the first parameter of the satellite, to reduce a demodulation threshold of the preamble sequence, so that a reduced demodulation threshold meets an uplink budget requirement of the NTN system.

With reference to the second aspect, in a possible design, the first parameter of the satellite includes a satellite type of the satellite and/or position information of the satellite.

With reference to the second aspect, in a possible design, the position information of the satellite includes an orbital altitude of the satellite and/or an elevation angle of the satellite.

With reference to the second aspect, in a possible design, a length of the preamble sequence in the preamble is 139, and the quantity of repetition times of the preamble sequence in the preamble is greater than 4. Alternatively, a length of the preamble sequence in the preamble is 839, and the quantity of repetition times of the preamble sequence in the preamble is greater than 12. According to this solution, for different lengths of the preamble sequence, the quantity of repetition times of the preamble sequence may be increased, so that a decoding threshold of the preamble meets the uplink budget requirement of the NTN system.

According to a third aspect, a communication apparatus is provided, configured to implement the foregoing methods. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

The communication apparatus includes a corresponding module, unit, or means (means) for implementing the foregoing method. The module, unit, or means may be implemented by hardware, software, or hardware executing corresponding software. The hardware or the software includes one or more modules or units corresponding to the foregoing functions.

According to a fourth aspect, a communication apparatus is provided, including a processor. The processor is configured to execute instructions stored in a memory, and when the processor executes the instructions, the communication apparatus performs the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

In a possible design, the communication apparatus further includes the memory, and the memory is configured to store computer instructions. Optionally, the processor and the memory are integrated together, or the processor and the memory are separately disposed.

In a possible design, the memory is coupled to the processor, and is outside the communication apparatus.

According to a fifth aspect, a communication apparatus is provided, including a processor and an interface circuit. The interface circuit is configured to communicate with a module other than the communication apparatus, and the processor is configured to perform the method in any one of the foregoing aspects by using a logic circuit or by running a computer program or instructions. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

Alternatively, the interface circuit may be a code/data read/write interface circuit, and the interface circuit is configured to receive computer-executable instructions (the computer-executable instructions are stored in a memory, and may be read from the memory directly or through another component) and transmit the computer-executable instructions to the processor, so that the processor runs the computer-executable instructions to perform the method in any one of the foregoing aspects.

In some possible designs, the communication apparatus may be a chip or a chip system.

According to a sixth aspect, a computer-readable storage medium is provided. The computer-readable storage medium stores instructions, and when the instructions are executed on a communication apparatus, the communication apparatus is enabled to perform the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

According to a seventh aspect, a computer program product including instructions is provided. When the computer program product runs on a communication apparatus, the communication apparatus is enabled to perform the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

According to an eighth aspect, a communication apparatus (for example, the communication apparatus may be a chip or a chip system) is provided. The communication apparatus includes a processor, configured to implement the function in any one of the foregoing aspects. In a possible design, the communication apparatus further includes a memory, and the memory is configured to store necessary program instructions and data. When the communication apparatus is the chip system, the communication apparatus may include a chip, or may include the chip and another discrete component.

For technical effects brought by any design manner in the third aspect to the eighth aspect, refer to the technical effects brought by different design manners in the first aspect and the second aspect. Details are not described herein again.

According to a ninth aspect, a communication system is provided. The communication system includes a terminal device and a network device. The terminal device is configured to perform the method in the first aspect. The network device is configured to perform the method in the second aspect.

### BRIEF DESCRIPTION OF DRAWINGS

FIG. 1 is a diagram of a network architecture of an NTN system according to an embodiment of this application;

FIG. 2 is a diagram of a basic preamble format according to an embodiment of this application;

FIG. 3 is a diagram of a structure of a communication system according to an embodiment of this application;

FIG. 4 is a diagram of structures of a network device and a terminal device according to an embodiment of this application;

FIG. 5 is a diagram of another structure of a terminal device according to an embodiment of this application;

FIG. 6 is an interaction diagram of a random access method according to an embodiment of this application;

FIG. 7 is an interaction diagram of another random access method according to an embodiment of this application;

FIG. 8 is an interaction diagram of still another random access method according to an embodiment of this application;

FIG. 9 is a diagram of a structure of a communication apparatus according to an embodiment of this application; and

FIG. 10 is a diagram of a structure of another communication apparatus according to an embodiment of this application.

### DESCRIPTION OF EMBODIMENTS

For ease of understanding the technical solutions in embodiments of this application, a conventional technology of this application is first briefly described as follows.

### 1. NTN System

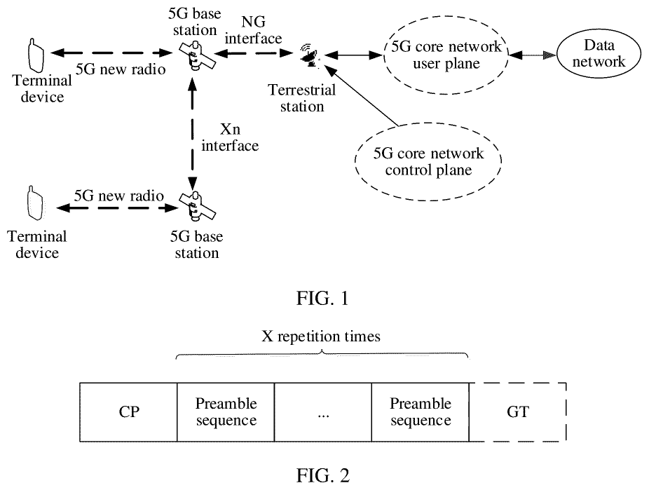

The NTN system includes nodes such as a satellite network, a high-altitude platform, and an uncrewed aerial vehicle. Currently, for a network architecture of an NTN system that integrates satellite communication and a 5G technology, refer to FIG. 1. As shown in FIG. 1, terminal devices on the ground access a network through 5G new radio. 5G base stations are deployed on satellites and are connected to a 5G core network on the ground over a radio link. In addition, a radio link exists between the satellites, to complete signaling exchange and user data transmission between the base stations on different satellites. Network elements in FIG. 1 and interfaces between the network elements are briefly described as follows:

Terminal device: The terminal device is a wireless communication device that supports the 5G new radio, for example, may be a mobile device such as a mobile phone. In the NTN system, the terminal device may access the satellite network through the 5G new radio and initiate a service such as a call or internet access.

5G base station: The 5G base station is mainly responsible for providing a wireless access service, scheduling a radio resource, and providing a reliable wireless transmission protocol, a reliable data encryption protocol, and the like for the terminal device.

5G core network: The 5G core network is mainly responsible for services such as user access control, mobility management, session management, user security authentication, and charging. The core network includes a plurality of functional units, which may be classified into a control plane function entity and a data plane function entity.

Data network: The data network is an operator network that provides a data transmission service for the terminal device.

Terrestrial station: The terrestrial station is mainly responsible for forwarding signaling and service data between the 5G base station on the satellite and the 5G core network on the ground.

5G new radio: The 5G new radio is a radio link between the terminal device and the base station.

Xn interface: The Xn interface is an interface between the 5G base stations, and is mainly configured to exchange signaling such as handover signaling.

NG interface: The NG interface is an interface between the 5G base station and the 5G core network, and is mainly configured to exchange core network signaling and user service data.

For the NTN system, the satellite is far away from the ground, and there is a factor such as rain attenuation. Consequently, a link budget is usually insufficient. For example, as shown in Table 1.

TABLE 1

| | | User equipment | Carrier-to-noise |
|---|---|---|---|
| | | position (user | ratio (carrier- |
| Range | | equipment position, | to-noise ratio, |
| (parameter) | Orbit (orbit) | UE position) | CNR) (dB) |
| Set (set) 1 | Geostationary earth | Edge (edge) | −17.177 |
| | orbit (geostationary | Center (center) | −16.943 |
| | earth orbit, GEO) | Nadir (nadir) | −15.908 |
| | Low earth orbit (low | Edge | −9.270 |
| | earth orbit, LEO)- | Center | −8.649 |
| | 1200 | Nadir | −4.217 |
| | LEO-600 | Edge | −3.876 |
| | | Center | −3.263 |
| | | Nadir | 1.803 |
| Set 2 | GEO | Edge | −21.977 |
| | | Center | −21.777 |
| | | Nadir | −20.908 |
| | LEO-1200 | Edge | −16.014 |
| | | Center | −14.649 |
| | | Nadir | −10.217 |
| | LEO-600 | Edge | −10.586 |
| | | Center | −9.263 |
| | | Nadir | −4.197 |

In Table 1, the range may represent a satellite scenario defined in a current standard, and the orbit may represent a satellite type of the satellite, or may represent an orbital altitude of the satellite. For example, the GEO represents that the satellite is a geostationary earth orbit satellite, the LEO represents that the satellite is a low earth orbit satellite, the LE0-1200 represents that the satellite is a low earth orbit satellite with an orbital altitude of 1200 km, and the LE0-600 represents that the satellite is a low earth orbit satellite with an orbital altitude of 600 km. The user equipment position represents a position of the terminal device in the NTN system. The CNR represents a CNR that needs to be met, and may represent a corresponding uplink budget or an uplink budget requirement that needs to be met. For example, in the set 1, if the satellite type is a GEO, and the user equipment position is an edge, a corresponding CNR is −17.177 dB. In other words, in the NTN system, if a satellite scenario is the set 1, the satellite type is the GEO, and the user equipment position is the edge, a required uplink budget is −17.177 dB.

It can be learned from Table 1 that, in the NTN system, uplink budgets in various scenarios are generally low. Especially, when the satellite type is the GEO, an uplink budget is the lowest, and may reach nearly −22 dB in the set 2. For an uplink, because a handheld terminal device usually uses omnidirectional antennas or a small quantity of antennas, an antenna gain of the handheld terminal device is low, and a transmit power is usually low. Consequently, an uplink budget in the NTN system becomes a severe bottleneck.

### 2. Random Access (Random Access, RA)

In the random access, that a terminal device completes uplink synchronization and switches from an idle state to a connected state is an important part in communication. The random access may be classified into contention-based random access (contention-based random access procedure, CBRA) and contention-free random access (contention-free random access, CFRA). A contention-based random access procedure is a procedure in which a network device does not allocate a dedicated preamble (preamble) and/or a physical random access channel (physical random access channel, PRACH) resource to the terminal device, but the terminal device randomly selects a preamble from a specified range and initiates random access. A contention-free random access procedure means that the terminal device initiates, based on an indication of a network device, random access on a specified PRACH resource by using a specified preamble.

According to different information exchange steps, the random access may be classified into 4-step random access (4-step random access channel, 4-step RACH) and 2-step random access (2-step random access channel, 2-step RACH). In comparison with the 4-step random access, in the 2-step random access, information exchange steps in the 4-step random access are combined, which reduces steps and time needed for a random access procedure.

The following describes a contention-based 4-step random access type (CBRA with 4-step RA type), which includes the following four steps.

Step 1: The terminal device sends a preamble to the network device on a PRACH resource, which is also referred to as sending a message1 (message1, Msg1). The PRACH resource is determined based on system information (system information) sent by the network device in a broadcast manner. When performing initial access or needing to re-access a network, the terminal device may perform downlink synchronization, and receive random access-related configuration information in the system information broadcast by the network device.

Step 2: After receiving the Msg1 sent by the terminal device, the network device sends a message2 (message2, Msg2) to the terminal device based on the random access preamble sent by the terminal device, where the Msg2 is also referred to as a random access response (random access response, RAR) message, and is a response of the network device to the received Msg1. The Msg2 includes configuration information such as a time-frequency resource position and a modulation and coding scheme that are used by the terminal device to send a Msg3.

Step 3: After receiving the Msg2, the terminal device sends the message3 (message3, Msg3) to the network device on a corresponding time-frequency resource based on the configuration information in the Msg2. The Msg3 is used for contention resolution. If a plurality of different terminal devices use a same random access preamble to perform random access, whether a conflict exists may be determined by using both the Msg3 and a Msg4. Transmission content of the Msg3 is a higher layer message, and the content of the Msg3 is not fixed. For example, the Msg3 may be a radio resource control (Radio Resource Control, RRC) connection setup request message. Currently, the Msg3 is defined in a protocol as a part of a random access procedure, and is transmitted on an uplink shared channel (uplink shared channel, UL-SCH). The Msg3 includes a cell radio network temporary identifier (cell radio network temporary identifier, C-RNTI), a media access control protocol (media access control, MAC) control information element (control element, CE), or a common control channel (common control channel, CCCH) service data unit (service data unit, SDU), which is submitted by an upper layer and associated with a contention resolution identity of the terminal device.

Step 4: After receiving the Msg3, the network device returns the message4 (message4, Msg4) to the terminal device. Information content included in the Msg4 is not fixed, and needs to correspond to the information content included in the Msg3, to be jointly used for the contention resolution. For example, it is assumed that the Msg3 sent by the terminal device includes the CCCH SDU. Correspondingly, if the terminal device detects, in the Msg4, the CCCH SDU sent by the terminal device in the Msg3, it is considered that the contention-based random access succeeds, and a subsequent communication process continues to be performed. For another example, it is assumed that the Msg3 includes the RRC connection setup request message, and the corresponding Msg4 may be one of the following two messages: an RRC connection reject message or an RRC connection setup message.

The following describes a contention-based 2-step random access type (CBRA with 2-step RA type), which includes the following two steps.

Step A: The terminal device sends a preamble and a physical uplink shared channel (physical uplink shared channel, PUSCH) payload (payload) to the network device, which is also referred to as sending a messageA (messageA, MsgA).

Step B: The network device sends a contention resolution message to the terminal device, where the contention resolution message may also be referred to as a messageB (messageB, MsgB) or a RAR message.

The MsgA provides functions of the Msg1 and the Msg3, and the MsgB provides functions of the Msg2 and the Msg4.

The following describes a contention-free 4-step random access type (CFRA with 4-step RA type), which includes the following three steps.

Step 0: The network device sends random access preamble assignment (RA preamble assignment) information to the terminal device.

Step 1: The terminal device sends a preamble to the network device.

Step 2: The network device sends a RAR message to the terminal device.

The following describes a contention-free 2-step random access type (CFRA with 2-step RA type), which includes the following three steps.

Step 0: The network device sends a preamble and PUSCH assignment information to the terminal device.

Step A: The terminal device sends a preamble and a PUSCH payload to the network device.

Step B: The network device sends a RAR message to the terminal device.

In conclusion, in each of the foregoing four types of random access types, the terminal device needs to send the preamble to the network device to initiate random access. Currently, for example, a basic preamble format may be shown in FIG. 2, and includes a preamble sequence, a cyclic prefix (cyclic prefix, CP), and an optional guard time (guard time, GT). The preamble sequence may be repeated for X times, and a value of X is related to a preamble format (which may also be referred to as a format of the preamble sequence or a preamble sequence format).

For example, for preamble sequences whose lengths are 139, Table 2 shows quantities of repetition times of the preamble sequences corresponding to different formats in an existing new radio (new radio, NR) standard.

TABLE 2

| Format | A1 | A2 | A3 | B1 | B2 | B3 | B4 | C0 | C2 |
|---|---|---|---|---|---|---|---|---|---|
| Quantity of | 2 | 4 | 6 | 2 | 4 | 6 | 12 | 1 | 4 |
| repetition times | | | | | | | | | |

For preamble sequences whose lengths are 839, Table 3 shows quantities of repetition times of the preamble sequences corresponding to different formats in an existing NR standard.

TABLE 3

| Format | L0 | L1 | L2 |
|---|---|---|---|
| Quantity of repetition times | 1 | 2 | 4 |

Currently, in an NR system, a performance requirement on a PRACH channel includes that a detection error probability is less than 1%. Simulation is performed on preamble sequences whose formats are currently supported by NR, for example, the preamble sequence whose length is 839 and the preamble sequence whose length is 139, to obtain signal-to-noise ratio (signal-to-noise ratio, SNR) values corresponding to a detection error probability of 1%. It may be determined based on an obtained simulation result that, for the preamble sequence whose length is 139, a format B4 has best performance in existing preamble sequence formats, and an SNR value corresponding to the error probability of 1% (which may also be understood as a decoding threshold) corresponding to the format B4 is approximately −12.5 dB; and for the preamble sequence whose length is 839, a format L2 has best performance in the existing preamble sequence formats, and a decoding threshold corresponding to the format L2 is approximately −17 dB. However, the decoding threshold corresponding to the format B4 or the format L2 still cannot meet uplink budgets required in many scenarios in an NTN system. For example, it can be learned from Table 1 that, in the set 2, when the satellite type is the GEO, the uplink budget may reach nearly-22 dB, and neither the decoding threshold corresponding to the format B4 nor the decoding threshold corresponding to the format L2 can meet the uplink budget. Therefore, corresponding technology enhancement for the random access to increase an uplink budget of the random access is critical to meeting uplink budgets required in some scenarios (for example, the NTN system) in which the uplink budgets are insufficient.

The following describes the technical solutions in embodiments of this application with reference to the accompanying drawings in embodiments of this application. In descriptions of this application, unless otherwise specified, “/” represents an “or” relationship between associated objects. For example, A/B may represent A or B. In this application, “and/or” describes only an association relationship for describing associated objects and represents that three relationships may exist. For example, A and/or B may represent the following three cases: Only A exists, both A and B exist, and only B exists, where A or B may be singular or plural. In addition, in the descriptions of this application, “a plurality of” means two or more than two unless otherwise specified. “At least one of the following items (pieces)” or an expression similar thereto means any combination of these items, including a singular item (piece) or any combination of plural items (pieces). For example, at least one of a, b, or c may indicate: a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, terms such as “example” or “for example” represents giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

It should be noted that the network architecture and the service scenario described in embodiments of this application are intended to describe the technical solutions in embodiments of this application more clearly, and do not constitute a limitation on the technical solutions provided in embodiments of this application. A person of ordinary skill in the art may learn that the technical solutions provided in embodiments of this application are also applicable to a similar technical problem as the network architecture evolves and a new service scenario emerges.

A random access method provided in embodiments of this application may be applicable to various communication systems. For example, the random access method provided in embodiments of this application may be applied to a long term evolution (long term evolution, LTE) system, a 5G system, an NTN system, or another future-oriented new communication system. This is not specifically limited in embodiments of this application. In addition, terms “system” and “network” are interchangeable.

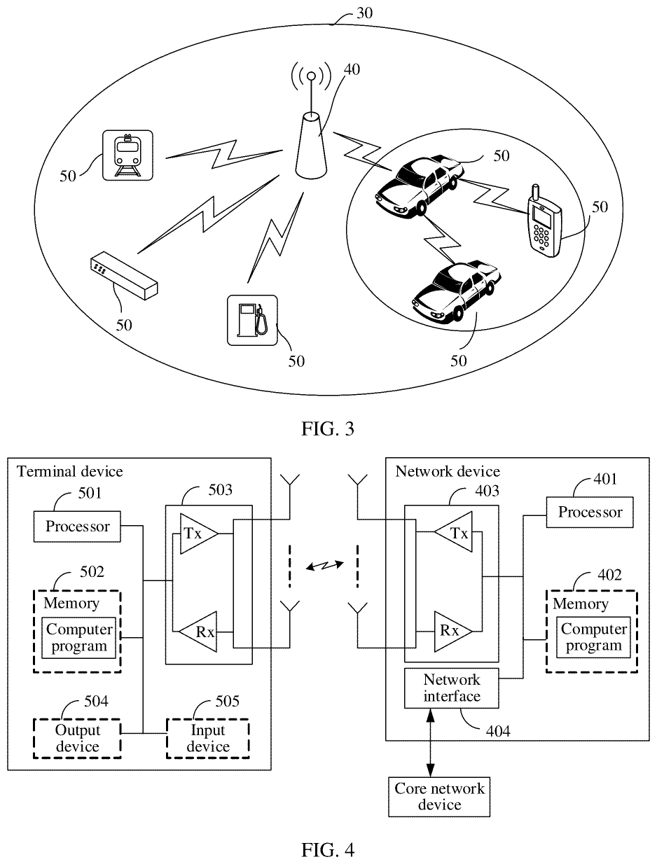

FIG. 3 shows a communication system 30 according to an embodiment of this application. The communication system 30 includes a network device 40 and one or more terminal devices 50. The terminal device 50 may communicate with the network device 40 in a wireless manner. Optionally, different terminal devices 50 may communicate with each other. The terminal device 50 may be located at a fixed position, or may be mobile.

It should be noted that FIG. 3 is merely a diagram. Although not shown, the communication system 30 may further include another network device. For example, the communication system 30 may further include one or more of a core network device, a wireless relay device, and a wireless backhaul device. This is not specifically limited herein. The network device may be connected to the core network device in a wireless or wired manner. The core network device and the network device 40 may be different independent physical devices, functions of the core network device and logical functions of the network device 40 may be integrated into a same physical device, or a part of the functions of the core network device and a part of the functions of the network device 40 may be integrated into one physical device. This is not specifically limited in this embodiment of this application.

For example, the network device 40 shown in FIG. 3 interacts with any terminal device 50. In the random access method provided in embodiments of this application, the terminal device 50 is configured to obtain first configuration information, where the first configuration information indicates a maximum quantity of repeated sending times of a preamble, and the maximum quantity of repeated sending times of the preamble is greater than 200. The terminal device 50 is further configured to send one or more preambles to the network device 40 based on the first configuration information. Specific implementations and technical effects of the solution are described in detail in subsequent method embodiments, and details are not described herein again.

Optionally, the communication system 30 shown in FIG. 3 may be applied to the network architecture shown in FIG. 1. This is not specifically limited in this embodiment of this application.

For example, if the communication system shown in FIG. 3 is applied to the network architecture shown in FIG. 1, the terminal device 50 in FIG. 3 may be the terminal device in the network architecture shown in FIG. 1. The network device 40 in FIG. 3 may be the 5G base station in the network architecture shown in FIG. 1. This is not specifically limited in this embodiment of this application.

Optionally, the network device in embodiments of this application is a device that connects the terminal device and a wireless network. The network device in embodiments of this application may include base stations (base station) in various forms, for example, may be a macro base station, a micro base station (also referred to as a small cell), a relay station, an access point, a transmitting point (transmitting point, TP), an evolved NodeB (evolved NodeB, eNodeB), a transmission reception point (transmission reception point, TRP), a next generation NodeB (next generation NodeB, gNB) in a 5G mobile communication system, a device that implements a base station function in a communication system evolved after 5G, a mobile switching center, a device that undertakes a base station function in device-to-device (Device-to-Device, D2D), vehicle-to-everything (vehicle-to-everything, V2X), or machine-to-machine (machine-to-machine, M2M) communication, or the like; may be a network device in an NTN communication system, in other words, may be deployed on a high-altitude platform or a satellite; or may be a module or a unit that completes a part of functions of a base station, for example, may be a central unit (central unit, CU) in a cloud access network (cloud radio access network, C-RAN) system, or may be a distributed unit (distributed unit, DU). A specific technology and a specific device form used by the network device are not limited in embodiments of this application. All or a part of functions of the network device may alternatively be implemented by using a software function running on hardware, or may be implemented by using an instantiated virtualization function on a platform (for example, a cloud platform). In this application, unless otherwise specified, the network device is a radio access network device.

Optionally, the terminal device in embodiments of this application may be a device having a wireless transceiver function, or may be referred to as a terminal (terminal). The terminal device may be specifically user equipment, an access terminal, a subscriber unit (subscriber unit), a subscriber station, a mobile station (mobile station), customer-premises equipment (customer-premises equipment, CPE), a remote station, a remote terminal, a mobile device, a mobile terminal, a user terminal, a wireless communication device, a user agent, a user apparatus, or the like. The terminal device may alternatively be a satellite phone, a cellular phone, a smartphone, a cordless phone, a session initiation protocol (session initiation protocol, SIP) phone, a wireless data card, a wireless modem, a tablet computer, a computer with a wireless transceiver function, a wireless local loop (wireless local loop, WLL) station, a personal digital processing (personal digital assistant, PDA), a handheld device with a wireless communication function, a computing device or another processing device connected to a wireless modem, a vehicle-mounted device, a communication device on a high-altitude aircraft, a wearable device, an uncrewed aerial vehicle, a robot, an intelligent point of sale (point of sale, POS) machine, a machine type communication device, a terminal device in D2D, a terminal device in V2X, a terminal device in virtual reality (virtual reality, VR), a terminal device in augmented reality (augmented reality, AR), a wireless terminal in industrial control (industrial control), a wireless terminal in self driving (self driving), a wireless terminal in remote medical (remote medical), a wireless terminal in smart grid (smart grid), a wireless terminal in transportation security (transportation safety), a wireless terminal in a smart city (smart city), a wireless terminal in a smart home (smart home), a terminal device in a future communication network, or the like. A specific technology and a specific device form used by the terminal device are not limited in embodiments of this application. All or a part of functions of the terminal device may alternatively be implemented by using a software function running on hardware, or may be implemented by using an instantiated virtualization function on a platform (for example, a cloud platform).

Optionally, in embodiments of this application, the network device and the terminal device may be deployed on the land, including an indoor device, an outdoor device, a handheld device, or a vehicle-mounted device; may be deployed on the water; or may be deployed on an airplane, a balloon, and a satellite in the air. Application scenarios of the network device and the terminal device are not limited in embodiments of this application.

Optionally, the network device and the terminal device in embodiments of this application may communicate with each other through a licensed spectrum, may communicate with each other through an unlicensed spectrum, or may communicate with each other through both a licensed spectrum and an unlicensed spectrum. The network device and the terminal device may communicate with each other through a spectrum below 6 gigahertz (gigahertz, GHz), may communicate with each other through a spectrum above 6 GHz, or may communicate with each other through both a spectrum below 6 GHz and a spectrum above 6 GHz. A spectrum resource used between the network device and the terminal device is not limited in embodiments of this application.

Optionally, the network device and the terminal device in embodiments of this application may alternatively be referred to as communication apparatuses, and each may be a general-purpose device or a dedicated device. This is not specifically limited in embodiments of this application.

Optionally, FIG. 4 is a diagram of structures of a network device and a terminal device according to an embodiment of this application. The terminal device 50 in FIG. 3 may use a structure of the terminal device shown in FIG. 4, and the network device 40 in FIG. 3 may use a structure of the network device shown in FIG. 4.

The terminal device includes at least one processor 501 and at least one transceiver 503. Optionally, the terminal device may further include at least one memory 502, at least one output device 504, or at least one input device 505.

The processor 501, the memory 502, and the transceiver 503 are connected through a communication line. The communication line may include a path for information transmission between the foregoing components.

The processor 501 may be a general-purpose central processing unit (central processing unit, CPU), another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor may be a microprocessor, or may be any regular processor or the like. During specific implementation, in an embodiment, the processor 501 may further include a plurality of CPUs, and the processor 501 may be a single-core processor or a multi-core processor. The processor herein may be one or more devices, circuits, or processing cores configured to process data.

The memory 502 may be an apparatus having a storage function, for example, may be a read-only memory (read-only memory, ROM) or another type of static storage device that can store static information and instructions, a random access memory (random access memory, RAM), or another type of dynamic storage device that can store information and instructions, or may be a programmable ROM (programmable ROM, PROM), an erasable PROM (erasable PROM, EPROM), an electrically erasable programmable read-only memory (electrically erasable programmable read-only memory, EEPROM), a compact disc read-only memory (compact disc read-only memory, CD-ROM) or other optical disk storage, optical disk storage (including a compact disc, a laser disc, an optical disc, a digital versatile disc, a Blu-ray disc, and the like), a magnetic disk storage medium or another magnetic storage device, or any other medium that can be configured to carry or store desired program code in a form of an instruction or a data structure and that can be accessed by a computer, but is not limited thereto. The memory 502 may exist independently, and is connected to the processor 501 through the communication line. Alternatively, the memory 502 and the processor 501 may be integrated together.

The memory 502 is configured to store computer-executable instructions for executing the solutions of this application, and the processor 501 controls the execution. Specifically, the processor 501 is configured to execute the computer-executable instructions stored in the memory 502, to implement the random access method in embodiments of this application.

Alternatively, optionally, in this embodiment of this application, the processor 501 may perform a processing-related function in the random access method provided in the following embodiment of this application, and the transceiver 503 is responsible for communicating with another device or a communication network. This is not specifically limited in this embodiment of this application.

Optionally, the computer-executable instructions in this embodiment of this application may also be referred to as application program code or computer program code. This is not specifically limited in this embodiment of this application.

The transceiver 503 may use any transceiver-type apparatus, and is configured to communicate with another device or a communication network such as the Ethernet, a radio access network (radio access network, RAN), or a wireless local area network (wireless local area network, WLAN). The transceiver 503 includes a transmitter (transmitter, Tx) and a receiver (receiver, Rx).

The output device 504 communicates with the processor 501, and may display information in a plurality of manners. For example, the output device 504 may be a liquid crystal display (liquid crystal display, LCD), a light emitting diode (light emitting diode, LED) display device, a cathode ray tube (cathode ray tube, CRT) display device, or a projector (projector).

The input device 505 communicates with the processor 501, and may accept user input in a plurality of manners. For example, the input device 505 may be a mouse, a keyboard, a touchscreen device, or a sensing device.

The network device includes at least one processor 401, at least one transceiver 403, and at least one network interface 404. Optionally, the network device may further include at least one memory 402. The processor 401, the memory 402, the transceiver 403, and the network interface 404 are connected through the communication line. The network interface 404 is configured to connect to a core network device through a link (for example, an SI interface), or connect to a network interface of another network device through a wired or wireless link (for example, an X2 interface) (not shown in the FIG. 4). This is not specifically limited in this embodiment of this application. In addition, for related descriptions about the processor 401, the memory 402, and the transceiver 403, refer to the descriptions about the processor 501, the memory 502, and the transceiver 503 in the terminal device. Details are not described herein again.

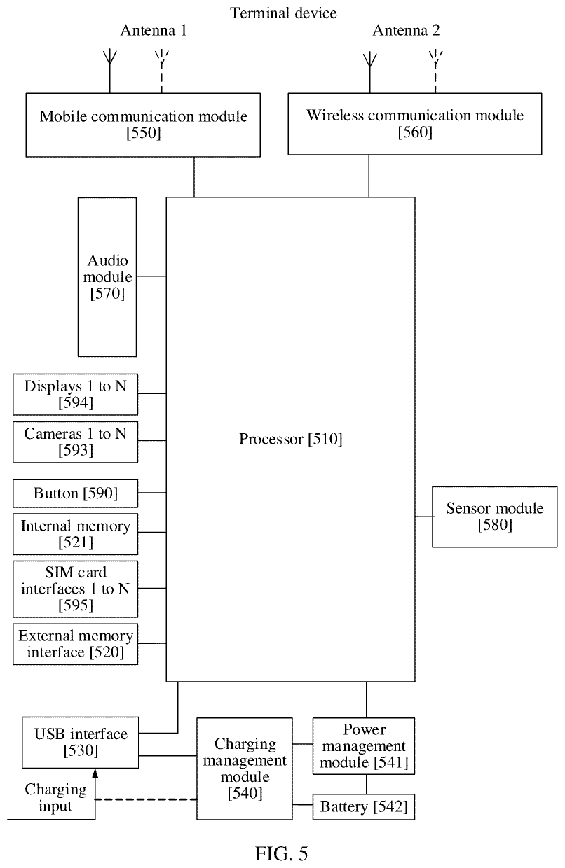

With reference to the diagram of the structure of the terminal device shown in FIG. 4, for example, FIG. 5 is a specific structural form of the terminal device according to an embodiment of this application.

In some embodiments, a function of the processor 501 in FIG. 4 may be implemented by a processor 510 in FIG. 5.

In some embodiments, a function of the transceiver 503 in FIG. 4 may be implemented by using an antenna 1, an antenna 2, a mobile communication module 550, a wireless communication module 560, or the like in FIG. 5. The mobile communication module 550 may provide a solution that is applied to the terminal device and that includes a wireless communication technology such as LTE, NR, or future mobile communication. The wireless communication module 560 may provide a solution that is applied to the terminal device and that includes a wireless communication technology such as WLAN (for example, a Wi-Fi network), Bluetooth (Bluetooth, BT), a global navigation satellite system (global navigation satellite system, GNSS), frequency modulation (frequency modulation, FM), near field communication (near field communication, NFC), or infrared. In some embodiments, the antenna 1 of the terminal device is coupled to the mobile communication module 550, and the antenna 2 is coupled to the wireless communication module 560, so that the terminal device can communicate with a network and another device by using a wireless communication technology.

In some embodiments, a function of the memory 502 in FIG. 4 may be implemented by using an internal memory 521 in FIG. 5, an external memory connected to an external memory interface 520, or the like.

In some embodiments, a function of the output device 504 in FIG. 4 may be implemented by using a display 594 in FIG. 5.

In some embodiments, a function of the input device 505 in FIG. 4 may be implemented by using a mouse, a keyboard, a touchscreen device, or a sensor module 580 in FIG. 5.

In some embodiments, as shown in FIG. 5, the terminal device may further include one or more of an audio module 570, a camera 593, a button 590, a subscriber identity module (subscriber identity module, SIM) card interface 595, a universal serial bus (universal serial bus, USB) interface 530, and a charging management module 540, a power management module 541, and a battery 542.

It may be understood that the structure shown in FIG. 5 does not constitute a specific limitation on the terminal device. For example, in some other embodiments of this application, the terminal device may include more or fewer components than those shown in the figure, or combine some components, or split some components, or have different component arrangements. The components shown in the figure may be implemented by hardware, software, or a combination of software and hardware.

With reference to FIG. 1 to FIG. 5, the following describes the random access method provided in embodiments of this application in detail by using an example in which the network device 40 shown in FIG. 3 interacts with any terminal device 50.

It should be noted that names of messages between network elements, names of parameters in the messages, or the like in the following embodiments of this application are merely examples, and may alternatively be other names during specific implementation. This is not specifically limited in embodiments of this application.

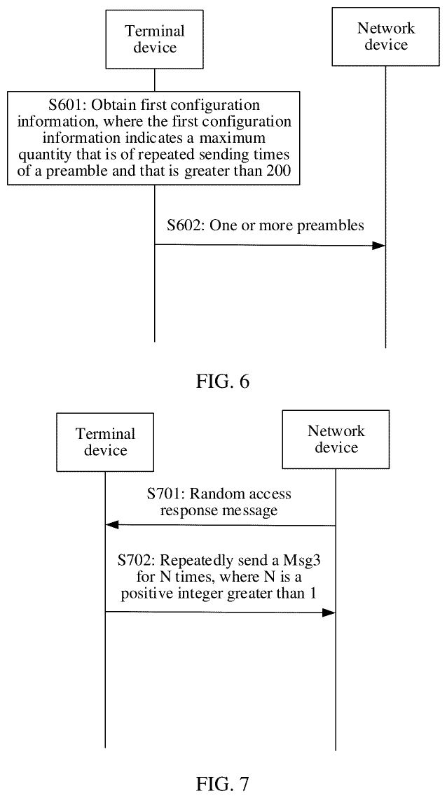

FIG. 6 is a random access method according to an embodiment of this application. In FIG. 6, the method is described by using an example in which a network device and a terminal device are execution bodies of an interaction example. However, the execution bodies of the interaction example are not limited in this application. For example, the network device in FIG. 6 may alternatively be a chip, a chip system, or a processor that supports the network device in implementing the method, or may be a logical module or software that can implement all or a part of functions of an application function network element. The terminal device in FIG. 6 may alternatively be a chip, a chip system, or a processor that supports the terminal device in implementing the method, or may be a logical module or software that can implement all or a part of functions of a first network element. The random access method includes S601 and S602.

S601: The terminal device obtains first configuration information, where the first configuration information indicates a maximum quantity of repeated sending times of a preamble, and the maximum quantity of repeated sending times of the preamble is greater than 200.

S602: The terminal device sends one or more preambles to the network device based on the first configuration information.

In an existing solution, a maximum quantity of repeated sending times of the preamble is 200. This value cannot meet an uplink budget requirement of some scenarios, for example, an NTN system. According to the random access method provided in this embodiment of this application, a maximum quantity of repeated sending times of the preamble is extended to more than 200. When the terminal device sends the preamble based on the maximum quantity of repeated sending times of the preamble, a final quantity of possible sending times of the preamble is increased accordingly, so that a decoding threshold for decoding the preamble by the network device can be reduced, and a link budget is increased to meet an uplink budget requirement of a scenario.

The random access method shown in FIG. 6 may be applied to 4-step random access and 2-step random access. The following describes S601 and S602 in detail.

For S601, in this embodiment of this application, the maximum quantity of repeated sending times of the preamble indicated by the first configuration information is greater than 200. In other words, the first configuration information is for extending the maximum quantity of repeated sending times of the preamble. To avoid ambiguity, the maximum quantity of repeated sending times of the preamble indicated by the first configuration information is referred to as an extended maximum quantity of repeated sending times of the preamble below, and the current maximum quantity of repeated sending times of the preamble is referred to as a maximum quantity of repeated sending times of the preamble before the extension.

After obtaining the first configuration information, the terminal device may determine, based on the first configuration information, the maximum quantity of repeated sending times of the preamble indicated by the first configuration information. The following describes how the terminal device obtains the first configuration information.

In a possible implementation, the network device may broadcast configuration information used by the terminal device to perform random access, where the configuration information carries the first configuration information. The terminal device may receive the information broadcast by the network device, to obtain the first configuration information, and determine the extended maximum quantity of repeated sending times of the preamble. Optionally, the network device may send the first configuration information to the terminal device by broadcasting a system message. In other words, the first configuration information may be carried in the system message broadcast by the network device. For example, the first configuration information may be carried in system information 2 (system information block 2, SIB2) broadcast by the network device.

Optionally, the first configuration information may be carried in information that is about a maximum quantity of preamble transmission times and that is broadcast by the network device. In other words, the information about the maximum quantity of preamble transmission times may indicate the extended maximum quantity of repeated sending times of the preamble. For example, the information about the maximum quantity of preamble transmission times may be a preamble Trans Max parameter.

Currently, information about the maximum quantity of preamble transmission times may indicate the maximum quantity of repeated sending times of the preamble before the extension. In the random access method provided in this embodiment of this application, numerical extension may be performed on the maximum quantity of repeated sending times of the preamble indicated by the information about the maximum quantity of preamble transmission times, so that the information about the maximum quantity of preamble transmission times may indicate the extended maximum quantity of repeated sending times of the preamble.

If the information about the maximum quantity of preamble transmission times indicates the extended maximum quantity of repeated sending times of the preamble, in a possible implementation, a quantity of bits occupied by the information about the maximum quantity of preamble transmission times may be increased, and the extended maximum quantity of repeated sending times of the preamble is indicated by using an increased quantity of bits. In another possible implementation, the extended maximum quantity of repeated sending times of the preamble may be indicated by using a bit that is in bits originally occupied by the information about the maximum quantity of preamble transmission times and that does not indicate the maximum quantity of repeated sending times of the preamble before the extension, where “the originally occupied bit” is a bit occupied by the current information about the maximum quantity of preamble transmission times. In this implementation, a quantity of bits occupied by the information about the maximum quantity of preamble transmission times may not be increased, thereby reducing resource overheads.

For example, if the information about the maximum quantity of preamble transmission times is the preamble Trans Max parameter, and it is assumed that the preamble Trans Max parameter currently occupies four bits, a preamble Trans Max ENUMERATED {n3, n4, n5, n6, n7, n8, n10, n20, n50, n100, n200} field may indicate that the maximum quantity of preamble transmission times before the extension may be 3, 4, 5, 6, 7, 8, 10, 20, 50, 100, or 200. In a possible implementation, after the numerical extension is performed based on the four bits occupied by the preamble Trans Max parameter, a preamble Trans Max ENUMERATED {n3, n4, n5, n6, n7, n8, n10, n20, n50, n100, n200, n300, n400, n500, n600} field may indicate that the extended maximum quantity of repeated sending times of the preamble may be 3, 4, 5, 6, 7, 8, 10, 20, 50, 100, 200, 300, 400, 500, or 600. In other words, the extended maximum quantity of repeated sending times of the preamble may still be indicated by using the four bits.

Alternatively, the first configuration information may be carried in power ramping step information broadcast by the network device. In other words, the power ramping step information may indicate the extended maximum quantity of repeated sending times of the preamble. For example, the power ramping step information may be a powerRampingStep parameter.

Currently, power ramping step information may indicate an increase value between a power at which the terminal device sends the preamble next time and a power at which the terminal device sends the preamble last time. In the random access method provided in this embodiment of this application, function extension may be performed on the power ramping step information, so that the power ramping step information indicates the extended maximum quantity of repeated sending times of the preamble.

Specifically, if the power ramping step information indicates the extended maximum quantity of repeated sending times of the preamble, a bit originally occupied by the power ramping step information may indicate the extended maximum quantity of repeated sending times of the preamble. The “originally occupied bit” is a bit occupied by the current power ramping step information. According to this solution, the extended maximum quantity of repeated sending times of the preamble can be indicated without an increase in a quantity of bits occupied by the power ramping step information, so that resource overheads are reduced.

For example, if the power ramping step information is the powerRampingStep parameter, and it is assumed that the powerRampingStep parameter currently occupies two bits, in a possible implementation, after the function extension is performed based on the two bits occupied by the powerRampingStep parameter, a powerRampingStep ENUMERATED {n300, n400, n500, n600} field may indicate that the extended maximum quantity of repeated sending times of the preamble may be 300, 400, 500, or 600.

Alternatively, the first configuration information may be carried in preamble target receive power information broadcast by the network device. In other words, the preamble target receive power information may indicate the extended maximum quantity of repeated sending times of the preamble. For example, the preamble target receive power information may be a preambleReceivedTargetPower parameter.

Currently, preamble target receive power information may indicate an initial power of the preamble that the network device expects to receive. In the random access method provided in this embodiment of this application, function extension may be performed on the preamble target receive power information, so that the preamble target receive power information indicates the extended maximum quantity of repeated sending times of the preamble.

Specifically, if the preamble target receive power information indicates the extended maximum quantity of repeated sending times of the preamble, a bit originally occupied by the preamble target receive power information may indicate the extended maximum quantity of repeated sending times of the preamble. The “originally occupied bit” is a bit occupied by the current preamble target receive power information.

For example, if the preamble target receive power information is the preambleReceivedTargetPower parameter, and it is assumed that the preambleReceivedTargetPower parameter currently occupies two bits, in a possible implementation, after the function extension is performed based on the two bits occupied by the preambleReceivedTargetPower parameter, a preambleReceivedTargetPower ENUMERATED {n300, n400, n500, n600} field may indicate that the extended maximum quantity of repeated sending times of the preamble may be 300, 400, 500, or 600.

For S602, after receiving the first configuration information, the terminal device may determine the extended maximum quantity of repeated sending times of the preamble based on the first configuration information, and send the preamble to the network device based on the extended maximum quantity of repeated sending times of the preamble, even if the terminal device receives a RAR message fed back by the network device. It may be understood that, that the terminal device sends a plurality of preambles to the network device may also be referred to as that the terminal device repeatedly sends a preamble to the network device for a plurality of times. A quantity of preambles sent by the terminal device to the network device or a quantity of times that the terminal device repeatedly sends the preamble to the network device does not exceed the extended maximum quantity of repeated sending times of the preamble indicated by the first configuration information.

Optionally, when sending the preamble to the network device, the terminal device may send the preamble to the network device based on a preconfigured preamble transmit power. In other words, a transmit power at which the terminal device sends the preamble each time is the preconfigured preamble transmit power. For example, the preconfigured preamble transmit power may be a preconfigured maximum preamble transmit power. In some scenarios in which uplink budgets are severely insufficient, for example, an NTN system, if the terminal device performs, based on a current power ramping mechanism, power ramping each time the terminal device sends a preamble, a required uplink budget may still fail to be met even if a transmit power of the preamble is a preconfigured maximum preamble transmit power. However, according to this solution, each time the terminal device sends the preamble, the terminal device sends the preamble based on the preconfigured preamble transmit power, and does not need to perform power ramping step by step, so that the decoding threshold for decoding the preamble by the network device can be reduced, and an uplink budget is increased to meet the uplink budget requirement of the scenario.

The following describes, based on different cases of the first configuration information, how the terminal device determines the transmit power for sending the preamble each time.

In a possible implementation, when the first configuration information is carried in the information about the maximum quantity of preamble transmission times, the terminal device may determine, based on the power ramping step information and the preamble target receive power information configured by the network device, the transmit power for sending the preamble each time. For a specific implementation in which the terminal device determines the transmit power of the preamble based on the power ramping step information and the preamble target receive power information, refer to the current power ramping mechanism. Details are not described herein.

Certainly, in this case, the terminal device may alternatively send the preamble to the network device based on the preconfigured preamble transmit power. This is not limited in this embodiment of this application.

In a possible implementation, when the first configuration information is carried in the power ramping step information or the preamble target receive power information, the terminal device may send the preamble to the network device based on the preconfigured preamble transmit power.

Optionally, after S602, the random access method provided in this embodiment of this application may further include the following steps.

S603: The terminal device receives the RAR message from the network device. For specific content of the RAR message, refer to an existing protocol. Details are not described herein.

Optionally, if the random access method shown in FIG. 6 is applied to contention-based 4-step random access, after S602, the method may further include the following steps.

S603: The terminal device receives the RAR message from the network device.

S604: The terminal device sends a Msg3 to the network device. The terminal device may send the Msg3 to the network device in a manner of an existing protocol. Alternatively, the terminal device may send the Msg3 to the network device in a manner shown in FIG. 7 (details are described below).

S605: The terminal device receives a Msg4 from the network device. For specific content of the Msg4, refer to the existing protocol. Details are not described herein.

FIG. 7 is another random access method according to an embodiment of this application. In FIG. 7, the method is described by using an example in which a network device and a terminal device are execution bodies of an interaction example. However, the execution bodies of the interaction example are not limited in this application. For example, the network device in FIG. 7 may alternatively be a chip, a chip system, or a processor that supports the network device in implementing the method, or may be a logical module or software that can implement all or a part of functions of an application function network element. The terminal device in FIG. 7 may alternatively be a chip, a chip system, or a processor that supports the terminal device in implementing the method, or may be a logical module or software that can implement all or a part of functions of a first network element. The random access method includes S701 and S702.

S701: The terminal device receives a random access response message from the network device.

S702: After receiving the RAR message, the terminal device repeatedly sends a Msg3 to the network device for N times, where N is a positive integer greater than 1.

In an existing solution, the terminal device needs to send the Msg3 to the network device only once. However, in some scenarios in which uplink budgets are severely insufficient, for example, an NTN system, if the network device receives the Msg3 only once, a decoding threshold for decoding the Msg3 is high. Consequently, the uplink budget is insufficient. According to the random access method provided in this embodiment of this application, the terminal device may repeatedly send the Msg3 to the network device, and a decoding threshold for decoding the Msg3 by the network device is correspondingly reduced, so that the uplink budget can be increased to meet the uplink budget requirement of the scenario.

The random access method shown in FIG. 7 may be applied to 4-step random access. The RAR message sent by the network device to the terminal device in S702 may also be referred to as a Msg2. The following describes S701 and S702 in detail.

For S701, after the terminal device sends one or more preambles to the network device, if the network device successfully decodes the preamble, the network device sends the RAR message to the terminal device. In other words, before S701, the terminal device sends the one or more preambles to the network device. The terminal device may send the preamble to the network device in a manner shown in FIG. 6. Alternatively, the terminal device may send the preamble to the network device in a manner of an existing protocol.

In S702, optionally, a quantity of times that the terminal device repeatedly sends the Msg3 to the network device, or a value of N, may be determined based on a preamble sequence format of the preamble (namely, the preamble sent by the terminal device to the network device in S601) or a quantity of repeated sending times of the preamble.

The preamble sequence format used to determine the quantity of repeated sending times of the Msg3 (the value of N) may be a current preamble sequence format, or may be a newly defined preamble sequence format. This is not specifically limited in this embodiment of this application. The quantity of repeated sending times of the preamble used to determine the quantity of repetition times of the Msg3 may be a current quantity of repeated sending times of the preamble before the extension, or may be an extended quantity of repeated sending times of the preamble. This is not specifically limited in this embodiment of this application.

Optionally, the terminal device may configure a mapping relationship between the preamble sequence format of the preamble or the quantity of repeated sending times of the preamble and the quantity of repetition times of the Msg3, so that the terminal device may determine the corresponding quantity of repetition times of the Msg3 based on the preconfigured mapping relationship and the preamble sequence format or the quantity of repeated sending times of the sent preamble.

For example, it is assumed that the terminal device preconfigures a mapping relationship between the preamble sequence format and the quantity of repetition times of the Msg3 in a table form. The mapping relationship in the table form may be shown in Table 4.

TABLE 4

| Preamble sequence format | Quantity of repetition times of the Msg3 |
|---|---|
| A1 | 2 |
| E1 | 4 |
| E2 | 6 |
| E3 | 8 |
| . . . | . . . |

In Table 4, A1 is a current preamble sequence format, and E1, E2, and E3 are newly defined preamble sequence formats. For example, E1, E2, or E3 may be obtained by increasing, based on a current preamble sequence format B4, a quantity of repetition times of a preamble sequence in the current preamble sequence format B4. If the preamble sequence format of the preamble sent by the terminal device to the network device is A1, the terminal device may determine that the corresponding quantity of repeated sending times of the Msg3 is 1. If the preamble sequence format of the preamble sent by the terminal device to the network device is E1, the terminal device may determine that the corresponding quantity of repeated sending times of the Msg3 is 2. If the preamble sequence format of the preamble sent by the terminal device is another preamble sequence format in Table 4, the corresponding quantity of repeated sending times of the Msg3 may be deduced by analogy.

In a possible implementation, the configured mapping relationship between the preamble sequence format of the preamble and the quantity of repetition times of the Msg3 may be determined based on an uplink budget requirement of a scenario or a service.

The following provides explanations with reference to examples. It is assumed that the preamble sequence format of the preamble is E1. Simulation is performed on different quantities of repeated sending times of the Msg3 to obtain SNR values corresponding to a detection error probability of 1%, and a quantity of repeated sending times of the Msg3 whose corresponding SNR value meets a specific threshold is determined as a quantity of repeated sending times of the Msg3 corresponding to E1. The threshold may be set based on the uplink budget requirement of the scenario or the service. For example, it is assumed that a CNR value that needs to be met in an application scenario is −17 dB, and the preamble sequence format of the preamble is E1. It is obtained through simulation that when the quantity of repeated sending times of the Msg3 is 2, an SNR value corresponding to the detection error probability of 1% is −10 dB; when the quantity of repeated sending times of the Msg3 is 3, an SNR value corresponding to the detection error probability of 1% is −15 dB; or when the quantity of repeated sending times of the Msg3 is 4, an SNR value corresponding to the corresponding detection error probability of 1% is −18 dB. −18 dB meets a requirement of the application scenario on the CNR value. In the mapping relationship between the preamble sequence format of the preamble and the quantity of repetition times of the Msg3, the quantity of repeated sending times of the Msg3 corresponding to the preamble sequence format E1 may be configured as 4.

Optionally, the network device may alternatively configure a mapping relationship between the preamble sequence format of the preamble or the quantity of repeated sending times of the preamble and the quantity of repetition times of the Msg3. After the terminal device sends the preamble to the network device, the network device may determine, based on the configured mapping relationship, the subsequent quantity of times that the terminal device repeatedly sends the Msg3.

In a possible implementation, the preamble sequence format used to determine the quantity of repetition times of the Msg3 may be a quantity of repetition times of a preamble sequence in the preamble. For example, as shown in FIG. 1, the quantity of repetition times of the preamble sequence is X. After the terminal device sends the preamble to the network device, the terminal device may determine the corresponding quantity of repeated sending times of the Msg3 based on a value of X.

Optionally, the preamble sequence used to determine the quantity of repeated sending times of the Msg3 may be in a first preamble sequence group, and all preamble sequences in the first preamble sequence group are preamble sequences used for uplink coverage enhancement. It may also be understood as that the first preamble sequence group is a preamble sequence group used to select a preamble sequence in an uplink coverage enhancement scenario. The terminal device may select a preamble sequence format from the first preamble sequence group as the preamble sequence format of the to-be-sent preamble, and determine the corresponding quantity of repeated sending times of the Msg3 based on the selected preamble sequence format. Correspondingly, if the network device determines that the preamble sequence in the preamble sent by the terminal device is in the first preamble sequence group, the network device may determine that the terminal device is to repeatedly send the Msg3. For example, a possible name of the first preamble sequence group may be a preamble sequence group C (Group C). Certainly, the name of the first preamble sequence group is not specifically limited in this embodiment of this application.

Alternatively, the preamble sequence used to determine the quantity of repeated sending times of the Msg3 may be in a preamble sequence group A (Group A) or a preamble sequence group B (Group B). In a current NR standard, preamble sequences are grouped into two groups: a group A and a group B. The network device may notify, by using broadcast configuration information used by the terminal device to perform random access, for example, by using a broadcast SIB2 message, the terminal device of a preamble sequence included in the group A and the group B respectively. Currently, a main difference between the group A and the group B lies in a size of data to be transmitted by the terminal device in the Msg3. If the size of the data to be transmitted by the terminal device is greater than a transmission size threshold of the Msg3, and a path loss is less than a configured specific value, the terminal device selects a preamble sequence in the group B. The terminal device may implicitly notify, by selecting a preamble sequence in the group A or the group B, the network device of the size of the data to be transmitted by the terminal device in the Msg3, so that the network device may allocate a corresponding uplink resource based on the size of the data.

Optionally, after S702, the random access method provided in this embodiment of this application may further include the following steps.

S703: The terminal device receives a Msg4 from the network device. For specific content of the Msg4, refer to an existing protocol. Details are not described herein.

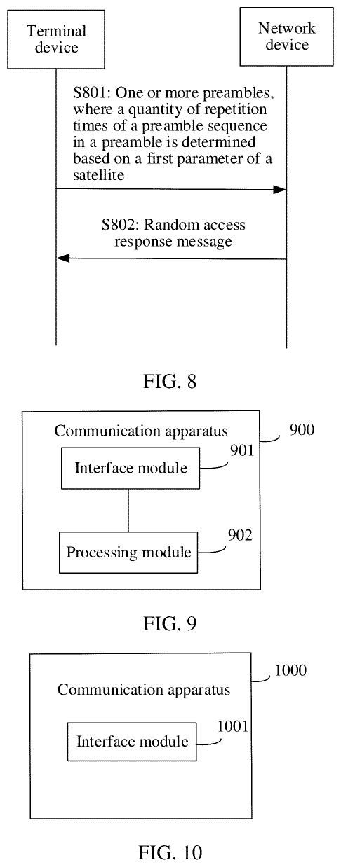

FIG. 8 is still another random access method according to an embodiment of this application. In FIG. 8, the method is described by using an example in which a network device and a terminal device are execution bodies of an interaction example. However, the execution bodies of the interaction example are not limited in this application. For example, the network device in FIG. 8 may alternatively be a chip, a chip system, or a processor that supports the network device in implementing the method, or may be a logical module or software that can implement all or a part of functions of an application function network element. The terminal device in FIG. 8 may alternatively be a chip, a chip system, or a processor that supports the terminal device in implementing the method, or may be a logical module or software that can implement all or a part of functions of a first network element. The random access method includes S801 and S802.

S801: The terminal device sends one or more preambles to the network device, where a quantity of repetition times of a preamble sequence in the preamble is determined based on a first parameter of a satellite.

S802: The terminal device receives a random access response message from the network device.

The random access method provided in this embodiment of this application may be applied to an NTN system. The terminal device may determine the quantity of repetition times of the preamble sequence in the preamble based on the first parameter of the satellite, to reduce a demodulation threshold of the preamble sequence, so that a reduced demodulation threshold meets an uplink budget requirement of the NTN system.

In S801, the terminal device may preconfigure a mapping relationship between the first parameter of the satellite and the quantity of repetition times of the preamble sequence in the preamble, to determine the corresponding quantity of repetition times of the preamble sequence based on the mapping relationship and the first parameter of the satellite. The quantity of repetition times of the preamble sequence corresponding to the first parameter of the satellite may be greater than a quantity of repetition times of a preamble sequence in a current preamble sequence format, or the quantity of repetition times of the preamble sequence in the current preamble sequence format may be reused.

Optionally, the first parameter of the satellite may include a satellite type of the satellite and/or position information of the satellite.

For example, the satellite type may include at least one of the following: a GEO satellite, a highly elliptical orbit (highly eccentric orbit, HEO) satellite, a medium earth orbit (medium earth orbit, MEO) satellite, an LEO satellite, and the like.

The position information of the satellite represents a position of the satellite in the NTN system. Optionally, the position information of the satellite may include information such as an orbital altitude of the satellite and/or an elevation angle of the satellite. For example, the elevation angle of the satellite may be 10 degrees, 20 degrees, 30 degrees, 40 degrees, or the like, and the orbital altitude of the satellite may be 500 km, 600 km, 730 km, 1200 km, or the like.

Optionally, when the first parameter of the satellite includes a plurality of pieces of information, corresponding quantities of repetition times of the preamble sequence may be independently determined based on different pieces of information, or the corresponding quantity of repetition times of the preamble sequence may be jointly determined based on the plurality of pieces of information. For example, it is assumed that the first parameter of the satellite includes the satellite type and the orbital altitude of the satellite. The satellite type includes a GEO satellite and an LEO satellite, and orbital altitudes corresponding to the LEO satellite include 600 and 1200. A quantity of repetition times of the preamble sequence corresponding to the GEO satellite is 32, a quantity of repetition times of the preamble sequence corresponding to an LEO satellite with an orbital altitude of 1200 is 80, and a quantity of repetition times of the preamble sequence in a current preamble sequence format B4 may be reused as a quantity of repetition times of the preamble sequence corresponding to an LEO satellite with an orbital altitude of 600.

Optionally, if lengths of preamble sequences are different, mapping relationships between the first parameter of the satellite and the quantity of repetition times of the preamble sequence may be different or the same.

For example, it is assumed that the first parameter of the satellite includes the satellite type and the orbital altitude of the satellite. The satellite type includes a GEO satellite and an LEO satellite, and orbital altitudes corresponding to the LEO satellite include 600 and 1200. For a preamble sequence whose length is 839, a quantity of repetition times of the preamble sequence corresponding to the GEO satellite is 32, a quantity of repetition times of the preamble sequence corresponding to an LEO satellite with an orbital altitude of 1200 is 80, and a quantity of repetition times of the preamble sequence in a current preamble sequence format B4 may be reused as a quantity of repetition times of the preamble sequence corresponding to an LEO satellite with an orbital altitude of 600. For a preamble sequence whose length is 839, a quantity of repetition times of the preamble sequence corresponding to the GEO satellite is 32, a quantity of repetition times of the preamble sequence in a current preamble sequence format L2 may be reused as a quantity of repetition times of the preamble sequence corresponding to an LEO satellite with an orbital altitude of 1200, and a quantity of repetition times of the preamble sequence in a current preamble sequence format L0 may be reused as a quantity of repetition times of the preamble sequence corresponding to an LEO satellite with an orbital altitude of 600.

In a possible implementation, the configured mapping relationship between the first parameter of the satellite and the quantity of repetition times of the preamble sequence may be configured based on the uplink budget requirement of the NTN system.

Optionally, in this implementation, the quantity of repetition times of the preamble sequence corresponding to the first parameter of the satellite may be a quantity of repetition times of a preamble sequence whose SNR value meets a specific threshold in a case of a detection error probability of 1%. The threshold may be set based on the uplink budget requirement of the NTN system (for example, may be a CNR that needs to be met). For example, to meet the uplink budget requirement of the NTN system, if a length of the preamble sequence in the preamble is 139, the quantity of repetition times of the preamble sequence in the preamble is greater than 4; or if a length of the preamble sequence in the preamble is 839, the quantity of repetition times of the preamble sequence in the preamble is greater than 12.

Optionally, there may be a mapping relationship between the first parameter of the satellite and a maximum quantity of repeated sending times of the preamble. In other words, the maximum quantity of repetition times of the preamble may be determined based on the first parameter of the satellite. The maximum quantity of repetition times of the preamble corresponding to the first parameter of the satellite may be greater than a current maximum quantity of repetition times of the preamble. In other words, the maximum quantity of repetition times of the preamble corresponding to the first parameter of the satellite is an extended maximum quantity of repeated sending times of the preamble. Alternatively, a current maximum quantity of repetition times of the preamble may be reused as the maximum quantity of repetition times of the preamble corresponding to the first parameter of the satellite.

After determining the corresponding quantity of repetition times of the preamble sequence based on the first parameter of the satellite, the terminal device determines, based on the determined quantity of repetition times of the preamble sequence, a preamble sequence format of the to-be-sent preamble, and sends the one or more preambles to the network device.

In S802, after the terminal device sends the preamble to the network device, if the network device successfully decodes the preamble, the network device sends the RAR message to the terminal device.

Optionally, the random access method shown in FIG. 6, the random access method shown in FIG. 7, and the random access method shown in FIG. 8 that are provided in embodiments of this application may be applied in combination with each other, or may be applied independently. This is not limited in embodiments of this application.

It may be understood that, in the foregoing embodiments, the methods and/or steps implemented by the terminal device may alternatively be implemented by a component (for example, a chip or a circuit) that can be used in the terminal device. The method and/or steps implemented by the network device (including a first network device, a second network device, or a third network device) may alternatively be implemented by a component (for example, a chip or a circuit) that can be used in the network device.

The foregoing mainly describes the solutions provided in embodiments of this application from the perspective of interaction between devices. Correspondingly, an embodiment of this application further provides a communication apparatus, and the communication apparatus is configured to implement the foregoing methods. The communication apparatus may be the terminal device in the foregoing method embodiment, an apparatus including the terminal device, or a component that can be used in the terminal device. Alternatively, the communication apparatus may be the network device in the foregoing method embodiment, an apparatus including the network device, or a component that can be used in the network device. It may be understood that, to implement the foregoing functions, the communication apparatus includes a corresponding hardware structure and/or software module for performing the function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on a particular application and a design constraint of the technical solutions. A person skilled in the art may use different methods to implement the described functions for each specific application. However, it should not be considered that this implementation goes beyond the scope of this application.

In embodiments of this application, the communication apparatus may be divided into functional modules based on the foregoing method embodiment. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, and is only logical function division. During actual implementation, another division manner may be used.

For example, the communication apparatus is the terminal device in the foregoing method embodiment. FIG. 9 is a diagram of a structure of a communication apparatus 900. The communication apparatus 900 includes an interface module 901 and a processing module 902. The interface module 901 may also be referred to as a transceiver module or a transceiver unit. The interface module 901 is configured to implement a transceiver function, and may be, for example, a transceiver circuit, a transceiver machine, a transceiver, or a communication interface.

In a possible design, the processing module 902 is configured to obtain first configuration information, where the first configuration information indicates a maximum quantity of repeated sending times of a preamble, and the maximum quantity of repeated sending times of the preamble is greater than 200. The interface module 901 is configured to send one or more preambles to a network device based on the first configuration information.

In a possible design, the interface module 901 is specifically configured to send the one or more preambles to the network device based on the first configuration information and a preconfigured preamble transmit power.

In a possible design, the first configuration information is carried in information that is about a maximum quantity of preamble transmission times and that is broadcast by the network device, or the first configuration information is carried in power ramping step information broadcast by the network device, or the first configuration information is carried in preamble target receive power information broadcast by the network device.

In a possible design, the interface module 901 is further configured to receive a random access response message from the network device, and repeatedly send a Msg3 to the network device for N times, where N is a positive integer greater than 1.

In a possible design, a value of N is determined based on a preamble sequence format of the preamble or a quantity of repeated sending times of the preamble.

In a possible design, a preamble sequence in the preamble is in a first preamble sequence group, and all preamble sequences in the first preamble sequence group are preamble sequences used for uplink coverage enhancement.

In a possible design, a preamble sequence in the preamble is in a preamble sequence group A or a preamble sequence group B.

In a possible design, a quantity of repetition times of the preamble sequence in the preamble is determined based on a first parameter of a satellite.

In a possible design, the first parameter of the satellite includes a satellite type of the satellite and/or position information of the satellite.

In a possible design, the position information of the satellite includes an orbital altitude of the satellite and/or an elevation angle of the satellite.

In a possible design, a length of the preamble sequence in the preamble is 139, and the quantity of repetition times of the preamble sequence in the preamble is greater than 4. Alternatively, a length of the preamble sequence in the preamble is 839, and the quantity of repetition times of the preamble sequence in the preamble is greater than 12.

In this embodiment, the communication apparatus 900 is presented in a form of functional modules obtained through division in an integrated manner. The module herein may be an ASIC, a circuit, a processor that executes one or more software or firmware programs, a memory, an integrated logic circuit, and/or another component capable of providing the foregoing functions.

In a simple embodiment, a person skilled in the art may figure out that the communication apparatus 900 may be in a form of the terminal device shown in FIG. 4.

For example, the processor 501 in the terminal device shown in FIG. 4 may invoke the computer-executable instructions stored in the memory 502, so that the terminal device performs the random access method in the foregoing method embodiment. Specifically, functions/implementation processes of the interface module 901 and the processing module 902 in FIG. 9 may be implemented by the processor 501 in the terminal device shown in FIG. 4 by invoking the computer-executable instructions stored in the memory 502. Alternatively, functions/implementation processes of the processing module 902 in FIG. 9 may be implemented by the processor 501 in the terminal device shown in FIG. 4 by invoking the computer-executable instructions stored in the memory 502, and functions/implementation processes of the interface module 901 in FIG. 9 may be implemented by using the transceiver 503 in the terminal device shown in FIG. 4.

Because the communication apparatus 900 provided in this embodiment can perform the foregoing random access method, for technical effects that can be obtained by the communication apparatus 900, refer to the foregoing method embodiment. Details are not described herein again.

For example, the communication apparatus is the network device in the foregoing method embodiment. FIG. 10 is a diagram of a structure of a communication apparatus 1000. The communication apparatus 1000 includes an interface module 1001. The interface module 1001 is configured to implement a transceiver function, and may be, for example, a transceiver circuit, a transceiver machine, a transceiver, or a communication interface.

In a possible design, the interface module 1001 is configured to receive one or more preambles from a terminal device, where a maximum quantity of repeated sending times of the preamble is greater than 200. The interface module 1001 is further configured to send a random access response message to the terminal device.

In a possible design, the interface module 1001 is further configured to send first configuration information to the terminal device, where the first configuration information indicates a maximum quantity of repeated sending times of the preamble.

In a possible design, the one or more preambles are sent based on a preconfigured preamble transmit power.

In a possible design, the first configuration information is carried in information that is about a maximum quantity of preamble transmission times and that is broadcast by the network device, or the first configuration information is carried in power ramping step information broadcast by the network device, or the first configuration information is carried in preamble target receive power information broadcast by the network device.

In a possible design, the interface module 1001 is further configured to receive a Msg3 repeatedly sent by the terminal device for N times, where N is a positive integer greater than 1.

In a possible design, a value of N is determined based on a preamble sequence format of the preamble or a quantity of repeated sending times of the preamble.

In a possible design, a preamble sequence in the preamble is in a first preamble sequence group, and all preamble sequences in the first preamble sequence group are preamble sequences used for uplink coverage enhancement.

In a possible design, a preamble sequence in the preamble is in a preamble sequence group A or a preamble sequence group B (Group B).

In a possible design, a quantity of repetition times of the preamble sequence in the preamble is determined based on a first parameter of a satellite.

In a possible design, the first parameter of the satellite includes a satellite type of the satellite and/or position information of the satellite.

In a possible design, the position information of the satellite includes an orbital altitude of the satellite and/or an elevation angle of the satellite.

In a possible design, a length of the preamble sequence in the preamble is 139, and the quantity of repetition times of the preamble sequence in the preamble is greater than 4. Alternatively, a length of the preamble sequence in the preamble is 839, and the quantity of repetition times of the preamble sequence in the preamble is greater than 12.

In this embodiment, the communication apparatus 1000 is presented in a form of functional modules obtained through division in an integrated manner. The module herein may be an ASIC, a circuit, a processor that executes one or more software or firmware programs, a memory, an integrated logic circuit, and/or another component capable of providing the foregoing functions.

In a simple embodiment, a person skilled in the art may figure out that the communication apparatus 1000 may be in a form of the network device shown in FIG. 4.

For example, the processor 401 in the network device shown in FIG. 4 may invoke the computer-executable instructions stored in the memory 402, so that the network device performs the random access method in the foregoing method embodiment. Specifically, functions/implementation processes of the interface module 1001 in FIG. 10 may be implemented by the processor 401 in the network device shown in FIG. 4 by invoking the computer-executable instructions stored in the memory 402. Alternatively, functions/implementation processes of the interface module 1001 in FIG. 10 may be implemented by using the transceiver 403 in the network device shown in FIG. 4.

Because the communication apparatus 1000 provided in this embodiment can perform the foregoing random access method, for technical effects that can be obtained by the communication apparatus 1000, refer to the foregoing method embodiment. Details are not described herein again.

It should be noted that one or more of the foregoing modules or units may be implemented by software, hardware, or a combination thereof. When any one of the foregoing modules or units is implemented by software, the software exists in a form of a computer program instruction, and is stored in the memory. The processor may be configured to execute the program instruction and implement the foregoing method procedure. The processor may be built into a SoC (system on chip) or an ASIC, or may be an independent semiconductor chip. In addition to a core that is configured to execute software instructions to perform an operation or processing, the processor may further include a necessary hardware accelerator, for example, an FPGA, a programmable logic device (programmable logic device, PLD), or a logic circuit that implements a dedicated logic operation.

When the foregoing modules or units are implemented by hardware, the hardware may be any one or any combination of a CPU, a microprocessor, a DSP chip, a micro control unit (microcontroller unit, MCU), an artificial intelligence processor, an ASIC, a SoC, an FPGA, a PLD, a dedicated digital circuit, a hardware accelerator, or a non-integrated discrete device. The hardware may run necessary software or do not depend on software to perform the foregoing method procedure.

Optionally, an embodiment of this application further provides a chip system, including: at least one processor and an interface. The at least one processor is coupled to a memory through an interface, and when the at least one processor executes a computer program or instructions in the memory, the method in any one of the foregoing method embodiments is performed. In a possible implementation, the communication apparatus further includes the memory. Optionally, the chip system may include a chip, or may include the chip and another discrete component. This is not specifically limited in this embodiment of this application.

All or a part of the foregoing embodiments may be implemented by software, hardware, firmware, or any combination thereof. When a software program is used to implement the embodiments, all or a part of the embodiments may be implemented in a form of a computer program product.

This application provides a computer program product, including one or more computer instructions. When the computer program product runs on a communication apparatus, any method in embodiments of this application is performed.

When the computer program instructions are loaded and executed on a computer, all or a part of procedures or functions according to embodiments of this application are generated. The computer may be a general-purpose computer, a dedicated computer, a computer network, or another programmable apparatus.

The computer instructions may be stored in a computer-readable storage medium. An embodiment of this application provides a computer-readable storage medium. The computer-readable storage medium stores instructions, and when the instructions are run on a communication apparatus, any method in embodiments of this application is performed.

The computer instructions may be transmitted from a computer-readable storage medium to another readable storage medium. For example, the computer instructions may be transmitted from a website, a computer, a server, or a data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (digital versatile disc, DVD)), a semiconductor medium (for example, a solid state drive (solid state drive, SSD)), or the like.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” (comprising) does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a better effect.

Although this application is described with reference to specific features and embodiments thereof, it is clear that various modifications and combinations may be made to them without departing from the protection scope of this application. Correspondingly, the specification and accompanying drawings are merely example descriptions of this application defined by the accompanying claims, and are considered as any of or all modifications, variations, combinations or equivalents that cover the scope of this application. This application is intended to cover these modifications and variations of this application provided that they fall within the scope of protection defined by the following claims and their equivalent technologies.

1. A random access method, wherein the method comprises:
obtaining, by a terminal device, first configuration information, wherein the first configuration information indicates a maximum quantity of repeated sending times of a preamble, and the maximum quantity of repeated sending times of the preamble is greater than 200; and
sending, by the terminal device, one or more preambles to a network device based on the first configuration information.

2. The method according to claim 1, wherein the sending, by the terminal device, one or more preambles to a network device based on the first configuration information comprises:
sending, by the terminal device, the one or more preambles to the network device based on the first configuration information and a preconfigured preamble transmit power.

3. The method according to claim 1, wherein the first configuration information is carried in information that is about a maximum quantity of preamble transmission times and that is broadcast by the network device; or
the first configuration information is carried in power ramping step information broadcast by the network device; or
the first configuration information is carried in preamble target receive power information broadcast by the network device.

4. The method according to claim 1, wherein the method further comprises:
receiving, by the terminal device, a random access response message from the network device; and
repeatedly sending, by the terminal device, a message3 (Msg3) to the network device for N times, wherein N is a positive integer greater than 1.

5. The method according to claim 4, wherein a value of N is determined based on a preamble sequence format of the preamble or a quantity of repeated sending times of the preamble.

6. The method according to claim 1, wherein a preamble sequence in the preamble is in a first preamble sequence group, and all preamble sequences in the first preamble sequence group are preamble sequences used for uplink coverage enhancement.

7. The method according to claim 1, wherein a preamble sequence in the preamble is in a preamble sequence group A or a preamble sequence group B.

8. The method according to claim 1, wherein a quantity of repetition times of the preamble sequence in the preamble is determined based on a first parameter of a satellite.

9. The method according to claim 8, wherein the first parameter of the satellite comprises a satellite type of the satellite and/or position information of the satellite.

10. The method according to claim 9, wherein the position information of the satellite comprises an orbital altitude of the satellite and/or an elevation angle of the satellite.

11. A communication apparatus, wherein the apparatus comprises an interface module and a processing module, wherein
the processing module is configured to obtain first configuration information, wherein the first configuration information indicates a maximum quantity of repeated sending times of a preamble, and the maximum quantity of repeated sending times of the preamble is greater than 200; and
the interface module is configured to send one or more preambles to a network device based on the first configuration information.

12. The apparatus according to claim 11, wherein the interface module is specifically configured to send the one or more preambles to the network device based on the first configuration information and a preconfigured preamble transmit power.

13. The apparatus according to claim 11, wherein the first configuration information is carried in information that is about a maximum quantity of preamble transmission times and that is broadcast by the network device; or
the first configuration information is carried in power ramping step information broadcast by the network device; or
the first configuration information is carried in preamble target receive power information broadcast by the network device.

14. The apparatus according to claim 11, wherein the interface module is further configured to receive a random access response message from the network device; and
the interface module is further configured to repeatedly send a message3 (Msg3) to the network device for N times, wherein Nis a positive integer greater than 1.

15. The apparatus according to claim 14, wherein a value of N is determined based on a preamble sequence format of the preamble or a quantity of repeated sending times of the preamble.

16. The apparatus according to claim 11, wherein a preamble sequence in the preamble is in a first preamble sequence group, and all preamble sequences in the first preamble sequence group are preamble sequences used for uplink coverage enhancement.

17. The apparatus according to claim 11, wherein a preamble sequence in the preamble is in a preamble sequence group A or a preamble sequence group B.

18. The apparatus according to claim 11, wherein a quantity of repetition times of the preamble sequence in the preamble is determined based on a first parameter of a satellite.

19. The apparatus according to claim 18, wherein the first parameter of the satellite comprises a satellite type of the satellite and/or position information of the satellite.

20. The apparatus according to claim 19, wherein the position information of the satellite comprises an orbital altitude of the satellite and/or an elevation angle of the satellite.
